(19) United States
(12) Patent Application Publication
(10) Pub. No.: US 2013/0238645 A1
(43) Pub. Date: Sep. 12, 2013

(54) System and Method for Facilitating a Spontaneous Social Meeting

(71) Applicant: Bobby Kennedy, Dothan, AL (US)

(72) Inventor: Bobby Kennedy, Dothan, AL (US)

(21) Appl. No.: 13/413,066

(22) Filed: Mar. 6, 2012

(51) Int. Cl. G06F 17/30; G06F 15/16

(52) U.S. Cl. 707/758; 707/E17.01

(57) ABSTRACT

A system and method for providing individuals with the opportunity to meet a desired individual in a spontaneous manner. The method consists of the steps of providing multiple users with computing devices connected to a network or interconnected networks. The users are provided with a graphical user interface to enter information confidentially relating to demographic data. Next, the users are provided a graphical user interface allowing the entry by the users of locational data. A database stores the data inputs for later use. A graphical user interface is provided to the user such that the user can enter search request inputs to request a report output relating to locational data connected with requested demographic data or in the alternative demographic data connected with requested locational data. Optional additional demographic data may be collected and used.

### BACKGROUND OF THE INVENTION

1. Field of the Invention

This invention relates to the field of social networking. More specifically, the present invention comprises a system and method for facilitating a spontaneous meeting between two or more individuals.

2. Description of the Related Art

Individuals utilize social media networks for various purposes, both personal and business. For example, numerous networks provide dating services, job placement services or simply a method to keep in touch with other individuals.

The increasing popularity of these networks has modified social behaviors to the extent that individuals communicate differently, meet in different manners and businesses thus advertise and reach out to consumers using new methods. While social networks provide for increased contact between individuals oftentimes that contact is briefer and less personal.

Many social networking sites are designed at connecting individuals using user-identified traits and/or preferences. Thus, these sites allow users to browse information about other individuals and initiate contact only if both parties are interested in beginning on on-line communication. Other sites collect information from all users and use a program to match users together based on whether they have compatible interests or opinions. While these social networking sites provide the ability for individuals to become connected, the meetings are often prescribed and certainly not spontaneous. A spontaneous meeting often allows individuals the ability to recognize non-verbal cues and avoid awkward meetings by assessing interest quickly.

Therefore, what is needed is a method or process to track where individuals with similar interests or goals are located at any given time or date, such that an individual can maximize the chance of meeting a desired individual in a spontaneous manner.

### BRIEF SUMMARY OF THE INVENTION

The present invention is a system and method for providing individuals with the opportunity to meet a desired individual in a spontaneous manner. The computer implemented method comprises the steps of first providing multiple users with computing devices connected to a network or networks, with a graphical user interface to enter information relating to demographic data, such as the relationship status or age group of the user. Second, the users are provided a graphical user interface allowing the entry by the users of locational data (consisting preferably of date/time/place). A database stores the information for later use. The users may search the database by locational data to view a particular place and what demographics will be at the particular place at a given date/time in a report output. The users may also search by demographic data to view where particular users of certain demographics will be located at given date/time. Optional additional demographic data may be collected and used (e.g. age, opinion, interests, etc.). All data is reported in a report output on a graphical user interface for easy viewing by the user. However, identifying data for a specific individual is held confidential.

### BRIEF DESCRIPTION OF THE SEVERAL VIEWS OF THE DRAWINGS

FIG. 1 is a schematic view of the flow of information in the present system and method.

FIG. 2 is a chart illustrating the user steps of the present system and method.

FIG. 3 is a screen shot view of a graphical interface illustrating a step within the present system and method.

FIG. 4 is a screen shot view of a graphical interface illustrating a step within the present system and method.

FIG. 5 is a screen shot view of a graphical interface illustrating a step within the present system and method.

FIG. 6 is a screen shot view of a graphical interface illustrating a step within the present system and method.

FIG. 7 is a schematic view illustrating the hardware components of the present system and method.

### REFERENCE NUMERALS IN THE DRAWINGS

| | |
|---|---|
| 10 present system | 12 computer system |
| 14 first location | 16 second location |
| 18 second users | 20 first users |
| 22 third users | 24 first graphical user interface |
| 26 file server | 28 first database |
| 30 second database | 32 computing device |
| 34 locational data input | 36 demographic data input |

38 second graphical user interface

| | |
|---|---|
| 40 fourth graphical user interface | 42 search data input |
| 44 calendar icon | 46 report output |
| 48 demographic data field | 50 locational data field |
| 52 search data field | 54 entered locational data |
| 56 third graphical user interface | 58 demographic data search input |
| 60 link | |

### DETAILED DESCRIPTION OF THE INVENTION

The present invention is a system and method for identifying where individuals having particular data associated therewith, will be located at any given date or time. The location identification is determined by collecting information from multiple individuals regarding a particular place, date and time. In its simplest embodiment the present system and method identifies all individuals as single or looking for friends and proceeds to collect data regarding the date, time and location where those individuals will be (“locational data”). The program will then allow other individuals to view the locational data associated with a particular number or group of single individuals. In its most complex embodiment the present system and method collects demographic data and associates group demographic data with the locational data.

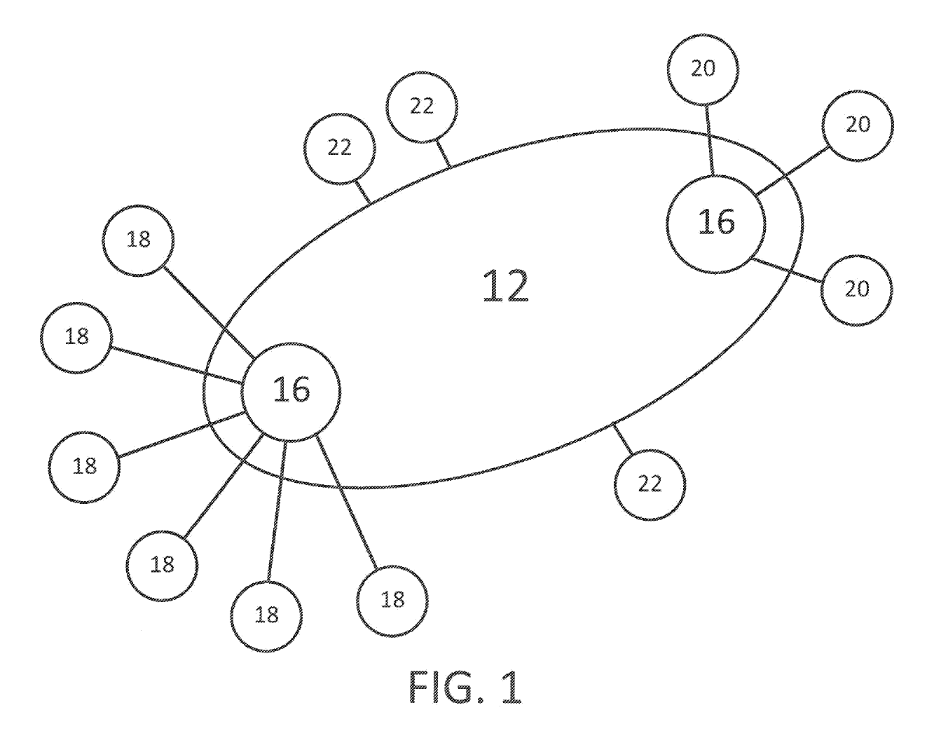

As an example, a simplified graphical representation of data collected in the present system 10 on a given date and time is shown in FIG. 1. Computer system 12 is central to the present system 10. Individuals or “users,” 18, 20, 22 access computer system 12 to input locational data. First users 20 have selected a first location 14 on a particular date, while second users 18 have selected a second location 16 at the same particular date. A third group of users 22 can use the computer system 12 to view the number of individuals attending either first location 14 or second location 16 at the given date (first and second users 20, 18 would also have access to this data). Thus, users can see that there would be 3 single individuals at first location 14 and 6 single individuals at second location 16 on the relevant date. While the system would not reveal the individuals names, the users would be able to maximize their chance of meeting a single individual by attending the second location versus the first location. In an alternate embodiment of the present system 10 additional demographic data would be collected and shown in connection with the locational data. Therefore, for example, using FIG. 1 as a guide, a user may search the locational data and find that first users 20, attending first location 14, range in age from 20-25 while second users 18, attending second location 16, range in age from 30-35. Again, this maximizes the opportunity for an individual to meet a desirable single individual in a more spontaneous manner. While the present system is described as benefitting single individuals it should not be limited to this use. As an example, users may be individuals, in a relationship or not, attempting to identify locations wherein a similar age range or other demographic is located for purposes of developing friendships or camaraderie or identifying family friendly locals. This may also apply to a business, wherein an entrepreneur or established company desires to establish a business or target a particular client network based on the specific demographic data established in the present system.

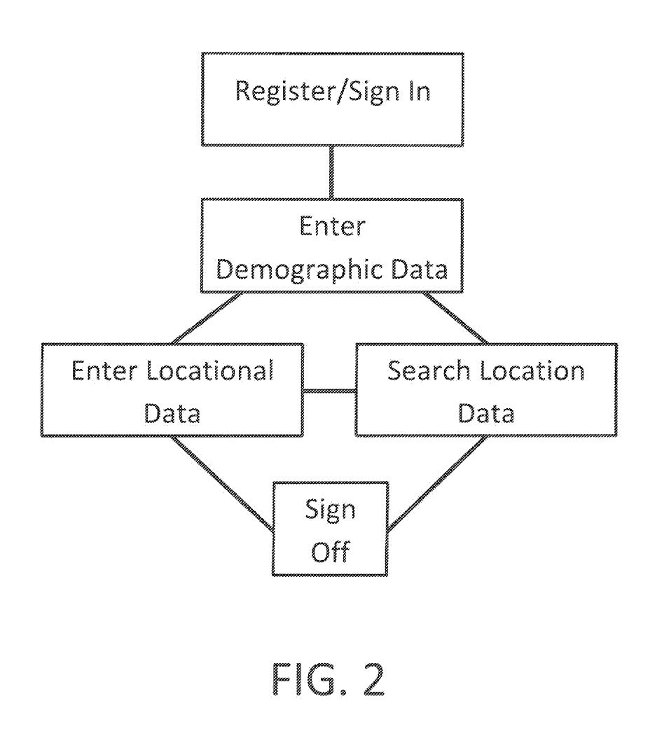

FIG. 2 shows generally the steps of the present method. First, the user either registers or signs in to a secure internet location, such as a web-site on a secure server. The user is directed to enter certain demographic data. In this step, the computer system can either verify or assume that the user is a single individual or collect additional information (age, religion, interests, education, food, language, occupation, smoking, drinking, etc). If the computer system collects additional information the program will direct the server to store the information In a first database (further described below). Next, the user can either proceed to enter known locational data (e.g. time and date that the user will attend particular locals), or, alternatively, search locational data to determine where individuals are located on particular dates and/or times. If the user chooses to enter locational data, the system will store that data in a second database, thereby increasing locational data available to all users. Once the user is done entering locational data, the user can move on to search or sign off. If the user chooses to search locational or demographic data the user will run a query identifying the data requested. The system will produce an output of information showing each location in connection with the number of individuals at that location. The personal information of particular individuals will not be displayed. The output can be presented in a number of different graphical formats, but generally, it would be important to show the number of individuals in a particular grouping in connection with a specific location on a specified date and/or time.

The present system may be set up such that the user makes payment to the system either upon registering or upon adding particular locations to search. For example, a user could request to have access to 10 locations in a particular area for a set amount of money or 50 locations in a particular area for a greater amount of money.

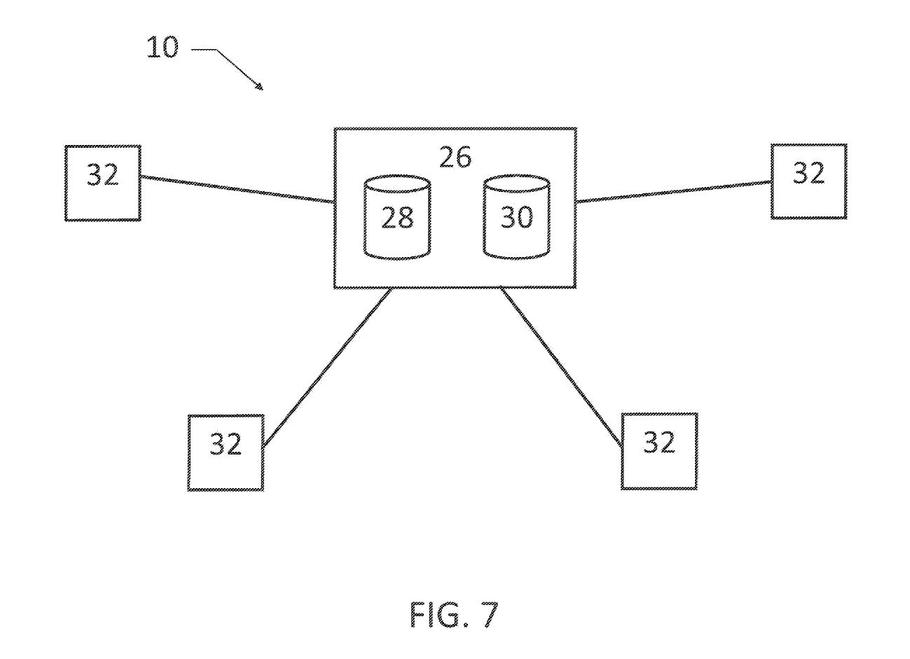

FIG. 7 illustrates the present system, tied to its hardware components. Because such a method must be implemented using a computer system, the description and examples focus on the computer-implemented method attached to the hardware components necessary to affect such method. As illustrated, server 26 is a central component to the present system. Server 26 can be any computer usable medium attached to a network with the purpose of storing computer files, such as computer readable code and databases, wherein “workstations” or computing devices 32 which are attached to the network can access such code, information or data. Thus, the term “server” should not be limiting, and should be read to include a file server or web server alike. Computer readable code, preferably stored on server 26 and run on various computing devices 32 enables the implementation of the present method and system for identifying locations wherein multiple individuals are located at a given date and time. The location identification is determined by collecting information regarding a particular place, date and time from multiple individuals using various computing devices 32. Computing devices 32 can be any type of device used to access the network, wherein the users of such computing devices 32 can enter and retrieve such information.

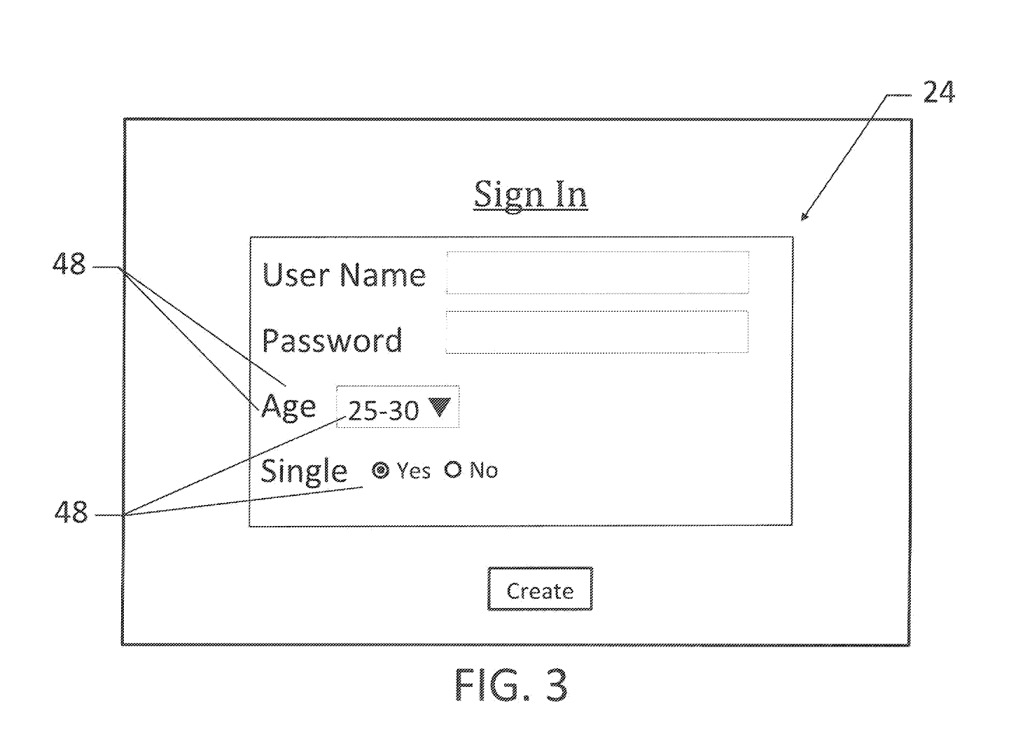

The collection of the necessary information from the user is best facilitated using a graphical user interface such as the ones illustrated in FIG. 3-6. First graphical user interface 24 generally includes open input fields, drop-down boxes, drag bars, selectable icons and check boxes for inputting the information. These specific types of input mechanisms are representative of the types of mechanisms that may be used to capture the information, but are in no way exhaustive of the possibilities. As shown in FIG. 3, demographic data field 48, which is a part of first graphical user interface 24, is displayed to the user, to prompt the user to enter the described information. In the present embodiment the method allows the user to sign in, and collects demographic data inputs 36, upon sign in or registration. As previously described, the present system could eliminate the demographic data inputs 36, simply classifying each user upon “sign in” or registration as “single” or “friend.” However, it is preferable, that such user would be classified using demographic data inputs 36 as illustrated. The demographic data inputs 36 can consist of any informational input, such as, education, food, language, interest, occupation, religion, smoking, drinking, etc. Once the user has completed demographic data fields 48, the system extracts the demographic data inputs 36 and inserts the data into first database 28, shown in FIG. 7. First database 28 stores the demographic data inputs for multiple users. While not illustrated and not integral to the present system and method, the individual's user name and password inputs (shown in FIG. 3) would also be stored for future access by that individual alone.

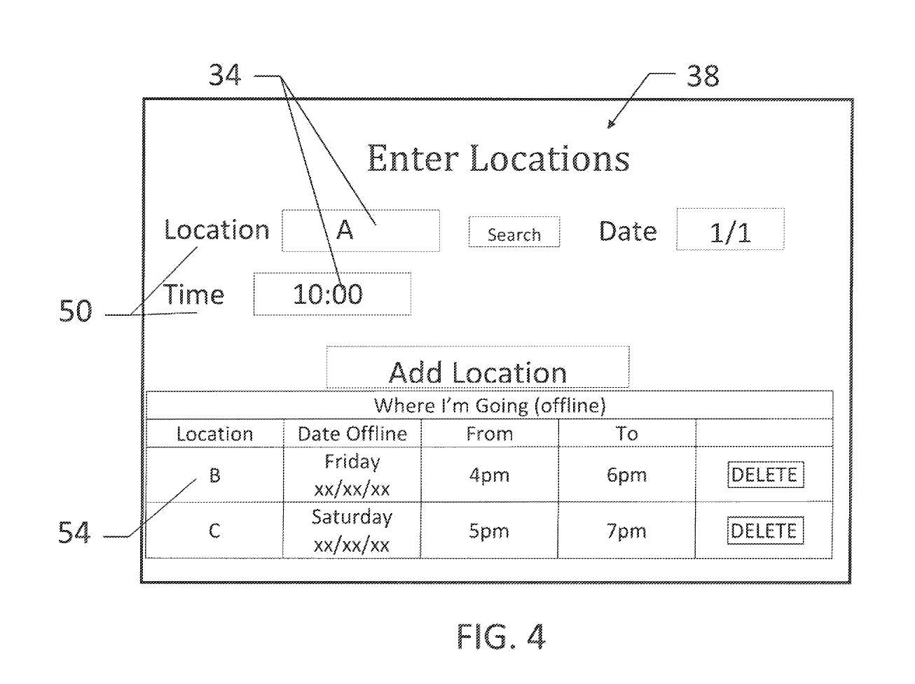

Upon sign in, the user would be brought to a second user graphical interface 38, illustrated in FIG. 4. FIG. 4 is a representative screen shot showing the entry of “locational data.” The interface shows the ability to enter a location or search for a particular location to enter. The user would be prompted by location data field 50 to enter locational data input 34 which would include the date and time that the location would be visited. Once “add location” is clicked, the present system and method would collect locational data inputs 34, storing such inputs to second database 30, illustrated in FIG. 7 (while a second database 30 is illustrated for the storage of locational data inputs, the first database 28 could be used as an alternative to store both sets of inputted information). The user is able to view and edit all of the entered locational data 54 on their profile. Thus, the “offline” summary is provided once a user selects “Add Location” in FIG. 4. The user can “delete” a specific locational data if the information changes or is incorrect. This profile specific information would not be visible to all users but only used confidentially to compile the anonymous locational data inputs.

Incentives may be used to avoid users simply searching the database as opposed to entering locational data inputs 34. For example, the system may allow users to see more locations upon entering more locations, thus encouraging users to share information about their future “offline” locational data (e.g. wherein “offline locational data” is a particular location that such user will visit at a date and time in the future; this term is not meant to be limited in meaning such that the identified user must be out of the network in order to qualify locational data as “offline”).

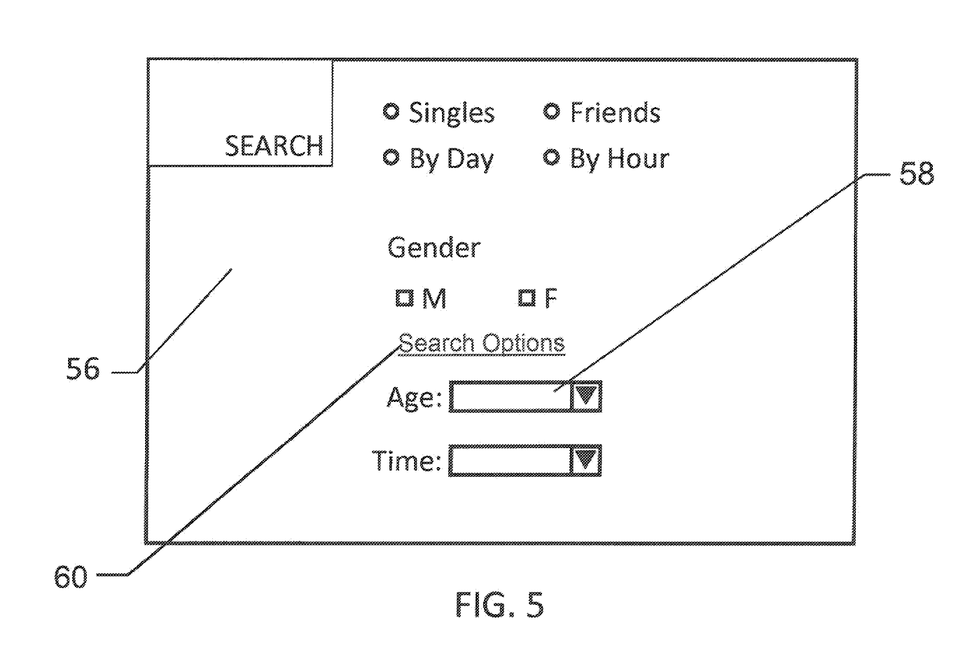

A screen shot of third graphical user interface 56 showing a simplified version of a search input screen in FIG. 5. The search screen could also be configured to be on the same page as the search results screen. As illustrated, the search may consist of selecting whether to search for singles or friends, by the day or hour, by female or male and a demographic data search input 58. Additionally, if desired, a link 60 could be provided to bring up additional search options for demographic data. When the user clicks on the link 60, the user brings up a list of demographic data search options, such as occupation, religion, smoking preference, drinking preference, food interests, etc. If selected the search results will specify where users with the selected preference will be located at the given time/date.

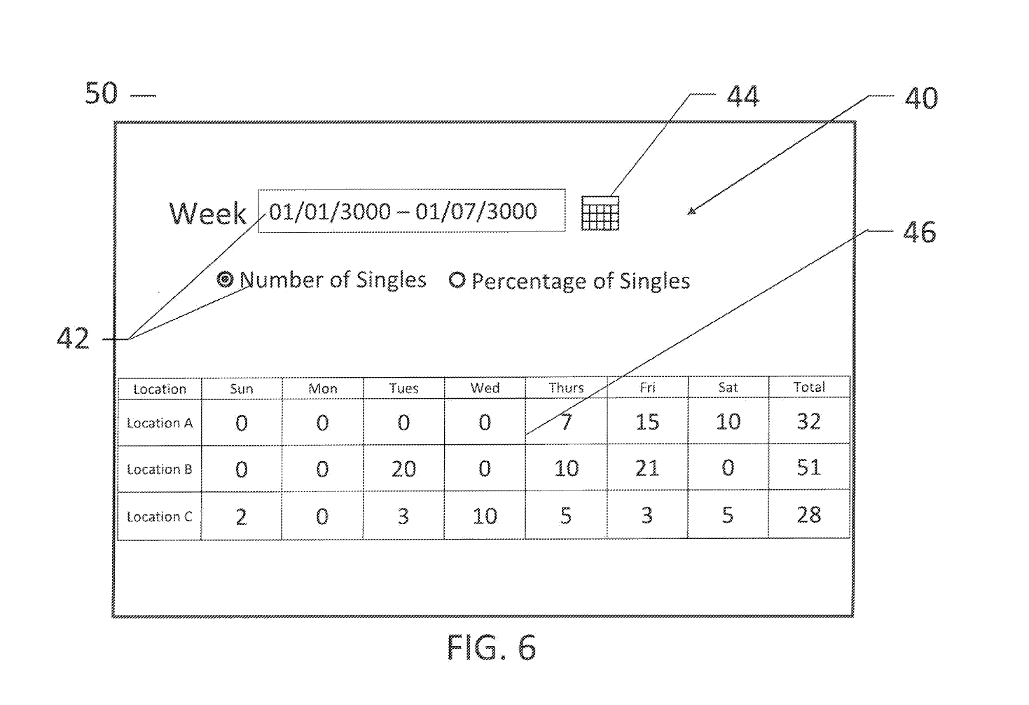

A screen shot of fourth graphical user interface 40 showing a simplified version of a search input and output from the present system illustrating “single” as the sole searchable demographic data is shown in FIG. 6. While FIG. 5 illustrates a simplified search interface, FIG. 6 shows a combined search and output. The user searching is able to choose a particular week of a month in search data field 52 for search data inputs 42. An optional calendar icon 44 can be shown to the right of the week entry field. The user can choose to identify a percentage of individuals or the exact number in connection with the particular location. Upon entering the search criteria, computer readable code runs a report accessing server 26 and databases 28, 30 for stored data relating to the search data inputs 42, shown in FIG. 7. As illustrated the number of individuals attending each location based on the particular day of the week is reported in report output 46 in FIG. 6. It is in this manner that the user can view locational data relating to a particular class or sub-class of individuals. The report output 46 can include additional information or data, but is generally presented as shown.

The preceding description contains significant detail regarding the novel aspects of the present invention. It should not be construed, however, as limiting the scope of the invention but rather as providing illustrations of the preferred embodiments of the invention. Thus, the scope of the invention should be fixed by the following claims, rather than by the examples given.

1. A method for identifying the population of users at particular locations, at a given date and time, further comprising the steps of:
a providing a computer usable medium having a computer usable code embodied therein;
b. providing computing devices to multiple users to access said computer usable code via a computer network;
c. providing a first graphical user interface having a demographic data field to prompt said users to enter demographic data input;
i. wherein said demographic data input is stored on a database;
d. providing a second graphical user interface having a locational data field to prompt said users to enter said locational data input;
i. wherein said locational data input is stored on said database;
e. providing a third graphical user interface wherein said multiple users can request said locational data inputs in connection with said demographic data inputs; and
f. providing a report output showing said locational data inputs in connection with anonymous user demographic data inputs.

2. The method of claim 1, wherein said computer usable medium is a file server.

3. The method of claim 2, wherein said database is located on said file server.

4. The method of claim 3, wherein said demographic data fields include an age range.

5. The method of claim 4, wherein said demographic data fields include a series of extracurricular interests.

6. The method of claim 4, wherein said locational data fields include a time and a date.

7. The method of claim 1, wherein said search data field includes at least one location, and wherein said report output contains said demographic data relating to said at least one location.

8. The method of claim 1, farther comprising the step of maintaining confidential data relating to the link between said demographic data and said locational data and a specific user.

9. The method of claim 1, wherein said second graphical user interface includes a search icon which connects said users to a searchable database of locations in a particular zip code.

10. A non-transitory computer readable medium containing a compute readable code for implementing a method on interconnected computer networks for identifying locational data of users associated with demographic data at a given date and time, further comprising the steps of:
providing a first graphical user interface on a computing device connected to said interconnected computer networks for said users to enter said demographic data;
b. obtaining and storing said demographic data relating to said users on a database located on a database on a server on said interconnected computer networks;
c. providing a second graphical user interface on a computer device connected to said interconnected computer networks for said user to enter said locational data;
d. obtaining and storing said locational data relating to said users on said database;
e. providing a third graphical user interface on a computing device connected to said interconnected computer networks for said users to enter said search data;
f. accessing said database by allowing said user to input a search criteria to run a query; and
g. providing a report output, wherein said report output provides a number corresponding to said demographic data and said locational data stored on said database.

11. The non-transitory, computer readable medium of claim 10, wherein said locational data consists of a date, a time and a place.

12. The non-transitory computer readable medium of claim 11, wherein said demographic data includes a relationship status.

13. The non-transitory computer readable medium of claim 12, wherein said demographic data includes an age range.

14. The non-transitory computer readable medium of claim 11, wherein said database is stored on a file server.

15. The non-transitory computer readable medium of claim 11, wherein said search data includes at least one location, and wherein said report output contains said demographic data relating to said at least one location.

16. The non-transitory computer readable medium of claim 11, wherein said demographic data includes a political preference.

17. The non-transitory computer readable medium of claim 11, wherein said demographic data includes a series of extracurricular interests.

18. The non-transitory computer readable medium of claim 11, further comprising the step of maintaining confidential data relating to the link between said demographic data and said locational data and a specific user.

19. The non-transitory computer readable medium of claim 11, wherein said second graphical user interface includes a search icon which connects said users to a searchable database of locations in a particular zip code.

20. The non-transitory computer readable medium of claim 11, wherein said search data relates to specific demographic data and wherein said report output relates such locational data with such demographic data requested.
